(19) United States
(12) Patent Application Publication
(10) Pub. No.: US 2007/0148060 A1
(43) Pub. Date: Jun. 28, 2007

(54) Stack gas decontamination system

(75) Inventors: Gennadiy Ivanovitch Klenov, Moscow (RU); Vladimir Petrovich Larionov, Moscow (RU); Aziz Khasaevich Kadymov, Moscow (RU); Gary F. Bowser, Auburn, IN (US)

Correspondence Address: COURSEY IP LAW, P.C., POST OFFICE BOX 29509, ATLANTA, GA, 30359, US

(73) Assignee: ScanTech Holdings, LLC, Atlanta, GA (US)

(21) Appl. No.: 10/570,677

(22) PCT Filed: Sep. 3, 2004
(86) PCT No.: PCT/US04/28960

§ 371 Date: Feb. 27, 2007

Related U.S. Application Data
(60) Provisional application No. 60/500,168, filed on Sep. 4, 2003.

(51) Int. Cl. B01J 19/08

(52) U.S. Cl. 422/186.04

(57) ABSTRACT

A system, including apparatuses and methods, for removing sulfur dioxide (SO₂) and nitrogen oxides (NOₓ) present in a stream of gases via a dual-stage irradiation process employing a pulsed electron accelerator in the first stage to remove a substantial majority of the sulfur dioxide (SO₂) from the stream of gases before removing a substantial majority of nitrogen oxides (NOₓ) from the stream of gases in the second stage. In an exemplary embodiment, the system comprises a stack gas decontamination system having a reactor with a first portion in which a pulsed electron accelerator initiates a first series of ionmolecular reactions in an ammonia-rich environment to convert the sulfur dioxide (SO₂) into sulfuric acid salts and a second portion in which at least one direct current electron accelerators initiates a second series of ion-molecular reactions in an ammonia-rich environment to convert the nitrogen oxides (NOₓ) into nitric acid salts.

### CROSS REFERENCE TO RELATED APPLICATION

This application claims the benefit of priority to United States Provisional Patent Application Ser. No. 60/500,168, which is entitled “STACK GAS DECONTAMINATION SYSTEM” and was filed on Sep. 4, 2003.

### FIELD OF THE INVENTION

The present invention relates, generally, to the field of apparatuses and methods for reducing emissions in stack gases and, more particularly, to the field of apparatuses and methods using charged particle accelerators to reduce the amount of sulfur dioxide (SO₂) and nitrogen oxides (NOₓ) in stack gases released from industrial facilities.

### BACKGROUND OF THE INVENTION

Over the years, a number of stack gas decontamination systems have been designed, developed, and/or constructed to treat stack gases produced by processes generally found at industrial enterprises or facilities. The processes often include combustion processes in which coal, oil, or natural gas is burned with by-product gases such as, but not limited to, sulfur dioxide (SO₂) and nitrogen oxides (NOₓ) being created and directed into the atmosphere as stack gases through conduits referred to as “stacks” or “flues”. Because the by-product gases travel through the stacks or flues, they are referred to, typically, as “stack gases” or “flue gases”. Such stack gas decontamination systems attempt to reduce the consequential pollution caused by the release of stack gases into the atmosphere by processing, treating, or “decontaminating”, the stack gases through the removal of harmful pollutants such as sulfur dioxide (SO₂) and nitrogen oxides (NOₓ) therefrom.

Many such stack gas decontamination systems employ electron accelerators operating in continuous mode. In one such system, sulfur dioxide (SO₂) and nitrogen oxides (NOₓ) are removed from a stack gas stream in an ammonia environment through the use of beams of accelerated electrons produced by electron accelerators operating in continuous mode. The stack gas stream, generally, contains water vapor and free radicals, including O, OH, and HO₂, are generated by emitting the accelerated electron beams into the stack gas in the ammonium environment. The radicals cause the oxidation of sulfur dioxide (SO₂) and nitrogen oxides (NOₓ) present in the stack gas stream into sulfuric acid (H₂SO₄) and nitric acid (HNO₃), respectively. Further interaction with the ammonia causes the generation of sulfuric and nitric acid salts in particulate, or powder, form that are subsequently removed from the stack gas stream by filters.

In a similar system for removing sulfur dioxide (SO₂) from a stack gas stream, a pulsed electron accelerator is employed in connection with a series of ion-molecular reactions involving O₃⁻ ion and accompanying free electron (e−) generation. The resulting oxidation of sulfur dioxide (SO₂) present in the stack gas stream produces sulfuric acid (H₂SO₄) that is removed via interaction with an ammonia environment.

While such systems can be relatively successful in removing sulfur dioxide (SO₂) and nitrogen oxides (NOₓ) present in a stack gas stream, such systems disadvantageously consume substantially large amounts of energy to perform such removal. Generally, the energy consumption of such systems is approximately 10 eV to 20 eV per molecule of treated stack gas.

There is, therefore, a need in the industry for a system, including apparatuses and methods, for removing sulfur dioxide (SO₂) and nitrogen oxides (NOₓ) present in the gases of a stack gas stream that has reduced energy consumption when compared to existing systems for doing same, and that address these and other related and unrelated shortcomings.

### SUMMARY OF THE INVENTION

Briefly described, the present invention comprises a system, including apparatuses and methods, for removing sulfur dioxide (SO₂) and nitrogen oxides (NOₓ) present in a stream of gases. More particularly, the present invention comprises a system, including apparatuses and methods, for removing sulfur dioxide (SO₂) and nitrogen oxides (NOₓ) present in a stream of gases via a dual-stage irradiation process employing a pulsed electron accelerator in the first stage to remove a substantial majority of the sulfur dioxide (SO₂) from the stream of gases before removing a substantial majority of nitrogen oxides (NOₓ) from the stream of gases in the second stage.

In an exemplary embodiment, the present invention comprises a stack gas decontamination system for removing sulfur dioxide (SO₂) and nitrogen oxides (NOₓ) present in a stream of gases having a reactor with a first portion in which a first series of ion-molecular reactions occur in an ammonia-rich environment to remove the majority of the sulfur dioxide (SO₂) from the stream of gases during a first stage of treatment and a second portion in which a second series of ion-molecular reactions occur in an ammonia-rich environment to remove the majority of the nitrogen oxides (NOₓ) from the stream of gases during a second stage of treatment. A pulsed electron accelerator is connected to the first portion of the reactor so that an electron beam including pulses of electrons is emitted into the stream of gases as they flow through the reactor's first portion to initiate the first series of ion-molecular reactions. At least one direct current electron accelerator is connected to the second portion of the reactor so that at least one electron beam is emitted into the stream of gases to initiate the second series of ion-molecular reactions as the gases flow through the reactor's second portion. The ion-molecular reactions that occur in the reactor's first and second portions produce sulfuric and nitric acid salts in powder, or particulate, form that are entrained in the stream of gases and subsequently removed by precipitation and/or filtration.

Advantageously, the present invention reduces the concentration of sulfur dioxide (SO₂) in a stream of gases during a first stage of processing before attempting to remove the nitrogen oxides (NOₓ) from the stream of gases during a second stage of processing. This is important since the efficiency of the subsequent removal of the nitrogen oxides (NOₓ) is dependent on the initial concentration of sulfur dioxide (SO₂) present. By separating the removal of sulfur dioxide (SO₂) and nitrogen oxides (NOₓ) from the stream of gases, respectively, into two stages and by substantially removing a majority of the sulfur dioxide (SO₂) from the stream of gases in the first stage, the efficiency associated with the removal of the nitrogen oxides (NOₓ) is substantially increased by the present invention. Further, the present invention's use of a pulsed electron accelerator during the first stage of treatment in conjunction with the use of one or more direct current electron accelerator(s) during the second stage of treatment results in the energy consumption per molecule of decontaminated gas being reduced from about 10 to 20 eV for systems having no pulsed electron accelerator and only one stage of treatment to about 1 to 5 eV for the system of the present invention.

Other objects, features, and advantages of the stack gas decontamination system will become apparent upon reading and understanding the present specification when taken in conjunction with the appended drawings.

### BRIEF DESCRIPTION OF THE DRAWINGS

FIG. 1 displays a block diagram representation of a stack gas decontamination system in accordance with an exemplary embodiment of the present invention.

FIG. 2 displays a diagram illustrating the treatment of an inlet gas stream (and, the effects thereof) by a portion of the stack gas decontamination system of FIG. 1 in accordance with methods of the exemplary embodiment of the present invention.

### DETAILED DESCRIPTION OF THE INVENTION

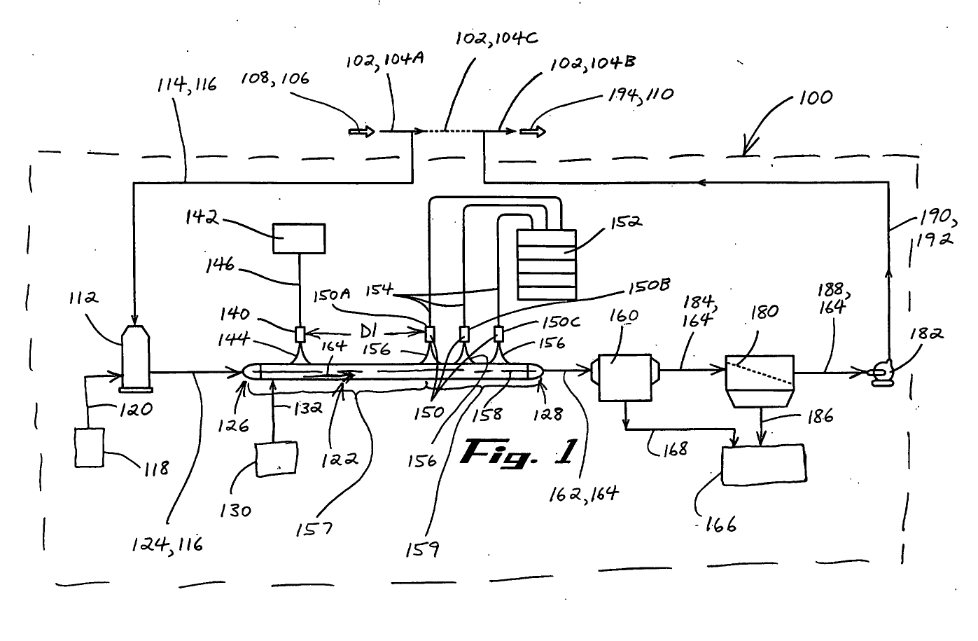

Referring now to the drawings in which like numerals represent like elements or steps throughout the several views, FIG. 1 displays a block diagram representation of a stack gas decontamination system 100 in accordance with an exemplary embodiment of the present invention. As illustrated in FIG. 1, the stack gas decontamination system 100 is connected to a conduit 102 having first and second portions 104A, 104B. The first portion 104A of conduit 102 is adapted to enable the flow therethrough of a first gas stream 106, produced and/or emitted by a process other than that of the present invention, substantially in the direction indicated by arrow 108. The process may, for example and not limitation, include the combustion of coal, oil, and/or natural gas such that conduit 102 may comprise a stack or flue through which a first gas stream 106 comprising by-product gases resulting from the combustion process are directed toward the atmosphere. It should be understood, however, that the scope of the present invention includes the treatment and decontamination of gas streams resulting from processes other than combustion and first gas streams 106 comprising other than combustion by-product gases. The second portion 104B of conduit 102 is adapted to allow a second gas stream 110 to flow therethrough toward the atmosphere or toward a device that is not part of the stack gas decontamination system 100.

The stack gas decontamination system 100 comprises a cooling tower 112 that is connected to the first portion 104A of conduit 102 by an inlet duct 114 for the gaseous communication of all, or a portion of, first gas stream 106 and the gases thereof, to the cooling tower 112. In the event that only a portion of first gas stream 106 is to be directed for decontamination, or treatment, by the stack gas decontamination system 100, conduit 102 further includes a third portion 104C (i.e., indicated by a dashed line in FIG. 1) connected between the first and second portions 104A, 104B thereof to direct the remaining portion of the first gas stream 106 therethrough to the second portion 104B of conduit 102. In such event, inlet duct 114 may be connected to both the first and third portions 104A, 104C of conduit 102. Regardless of whether all, or a portion of, first gas stream 106 is directed to the cooling tower 112 during operation of the stack gas decontamination system 100, the gas stream actually communicated by inlet duct 114 to the cooling tower 112 may sometimes be referred to herein as the “inlet gas stream 116”.

The cooling tower 112 is connected to a water source 118 for the receipt of cooling water therefrom via pipeline 120. The cooling tower 112, through use of the cooling water, is appropriately configured in accordance with the exemplary embodiment to reduce the temperature of the gases of the inlet gas stream 116 to approximately sixty-five degrees Celsius (65° C.) during operation.

The stack gas decontamination system 100 also comprises a reactor 122 that is connected to the cooling tower 112 by a connecting duct 124 to allow the inlet gas stream 116 to flow from the cooling tower 112 and into the reactor 122 during operation. The reactor 122 has a first end 126 proximate to which the connecting duct 124 is connected thereto, and has a second end 128 distant therefrom. An ammonia source 130 is also connected to the reactor 122 via a pipeline 132 that connects to the reactor 122 near the first end 126 thereof. According to the exemplary embodiment, the reactor 122 comprises a substantially cylindrically-shaped vessel of approximately 1.6 meters in diameter and 10 meters in length. It should be understood, however, that the scope of the present invention includes reactors 122 having different shapes and/or dimensions that are acceptable to perform in accordance with the structures and methods described herein.

As illustrated in FIG. 1, the stack gas decontamination system 100 additionally comprises a pulsed electron accelerator 140 and a high-voltage power supply 142. The pulsed electron accelerator 140 is connected to the reactor 122 near the first end 126 thereof by a connecting waveguide 144 that extends between the pulsed electron accelerator 140 and the reactor 122. The high-voltage power supply 142 is adapted to provide pulsed electrical power, via high-voltage power cable 146, to the pulsed electron accelerator 140 at appropriate voltages, currents, times, and pulse durations during operation of the stack gas decontamination system 100. The pulsed electron accelerator 140 is operable to produce and deliver an electron beam including pulses of electrons to the reactor 122 and the gases traveling therethrough during operation via connecting waveguide 144. Generally, a pulsed electron accelerator 140 acceptable in accordance with the exemplary embodiment, has an average power of more than 20 kW and produces an electron beam having electrons with energy levels between 0.8 MeV-1.2 MeV. It should be noted that while the exemplary embodiment includes only a single pulsed electron accelerator 140, the scope of the present invention includes similar stack gas decontamination systems having more than one pulsed electron accelerator 140. It should also be noted that the term “pulsed electron accelerator 140” includes all types of pulsed electron accelerators, including, without limitation, pulsed RF electron accelerators.

The stack gas decontamination system 100 further comprises a plurality of direct current electron accelerators 150 and a high-voltage power supply 152 that is connected to each of the direct current electron accelerators 150 by respective high-voltage power cables 154 for the delivery of electrical power to the direct current electron accelerators 150 from the high-voltage power supply 152. The direct current electron accelerators 150 are connected to the reactor 122 via respective waveguides 156 for the delivery of electron beams from the direct current electron accelerators 150 to the reactor 122 and to the gases flowing through the reactor 122 during operation. The direct current electron accelerators 150 are, generally, positioned proximate the second end 128 of the reactor 122 at different locations along a longitudinal axis 158 of the reactor 122 extending between the first and second ends 126, 128 thereof. The first direct current electron accelerator 150A is positioned at a distance, “D1”, relative to the pulsed electron accelerator 140 along the reactor's longitudinal axis 158. The location of first direct current electron accelerator 150A corresponds to the end of a first portion 157 of reactor 122 that begins at the first end 126 thereof, and to the beginning of a second portion 159 of reactor 122 that extends to the second end 128 thereof. The distance, “D1”, is selected such that the ion-molecular chemical reactions initiated by the pulsed electron accelerator 140 (as described herein) in the first portion 157 have sufficient time to proceed substantially or, perhaps, even complete before the gases flowing through reactor 122 enter the second portion 159 of reactor 122.

In accordance with the exemplary embodiment, an acceptable distance, “D1”, is approximately five (5) meters. The direct current electron accelerators 150, according to the exemplary embodiment, are each acceptably configured to have an accelerating voltage between approximately 400 kV and 800 kV, and a beam current of about 45 mA. The high-voltage power supply 152, according to the exemplary embodiment, is acceptably adapted to produce electrical power for the direct current electron accelerators 150 at voltages of between about 400 kV and 800 kV, a current of approximately 135 mA, and about 108 kW maximal power. It should be noted that while the exemplary embodiment includes a pulsed electron accelerator 140 positioned so that its electron beam will be encountered by the treated gas stream 164 prior to encountering electron beams from the direct current electron accelerators 150, the scope of the present invention includes similar stack gas decontamination systems having a pulsed electron accelerator 140 positioned so that its electron beam will be encountered by the treated gas stream 164 after encountering an electron beam from a direct current electron accelerator 150.

The stack gas decontamination system 100 still further comprises a precipitator 160 that is connected to the reactor 122 proximate its second end 128 by a connecting duct 162 to enable gases of the inlet gas stream 116 treated in the reactor 122 (sometimes referred to herein as “treated gas” that includes among other compounds or substances, sulfuric and nitric acid salts in powder, or particulate, form) to flow as a treated gas stream 164 from the reactor 122 to the precipitator 160. The precipitator 160 is adapted to remove the sulfuric and nitric acid salts in powder form from the treated gas stream 164. Generally, the precipitator 160 comprises an appropriately selected electrostatic precipitator, however, any appropriately selected precipitator, separator, or other device capable of removing particulates such as sulfuric and nitric acid salts from a gas stream is acceptable in accordance with the exemplary embodiment. The precipitator 160 is also connected to a solids disposal system 166 via a conveyor 168, or other comparable apparatus, for removal of the sulfuric and/or nitric acid salts (i.e., removed from the treated gas stream 164) from the precipitator 160 and appropriate disposal thereof.

According to the exemplary embodiment, the stack gas decontamination system 100 still further comprises a filter device 180 and a fan 182. The filter device is connected, through a connecting duct 184, to the precipitator 160. The filter device 180 is configured to receive the treated gas stream 164 from the precipitator 160, via connecting duct 184, and to remove additional sulfuric and nitric acid salts in powder form from the treated gas stream 164 not removed by the precipitator 160. The filter device 180 is connected, by a conveyor 186, or other comparable apparatus, to the solids disposal system 166 for the removal of the sulfuric and/or nitric acid salts (i.e., removed from the treated gas stream 164) from the filter device 180 and appropriate disposal thereof. The filter device 180, in accordance with the exemplary embodiment, comprises a bag filter or other comparable device selected and configured appropriately to remove particulates, including, but not limited to, sulfuric and/or nitric acids salts in powder form from a gas stream.

The filter device 180 is also connected, via a connecting duct 188, to the intake of fan 182 such that fan 182, during operation, induces the flow of the gases of the inlet and treated gas streams 116, 164, as appropriate, through the cooling tower 112, reactor 122, precipitator 160, and filter device 180. The outlet of fan 182 is connected to the second portion 104B of conduit 102 through an outlet duct 190, thereby enabling the treated gas stream 164 to flow from the fan 182 through outlet duct 190, as outlet gas stream 192, into the second portion 104B of conduit 102. In the event, as described above, that only a portion of first gas stream 106 is to be directed for decontamination, or treatment, by the stack gas decontamination system 100, the outlet duct 190 is also connected to the third portion 104C of conduit 102, thereby enabling the outlet gas stream 192 to be combined with the portion of the first gas stream 106 that is directed by the third portion 104C of conduit 102. The outlet gas stream 192 and the portion of the first gas stream 106 flowing through the third portion 104C of conduit 102, if any, form the second gas stream 110 that is directed by the second portion 104B of conduit 102 in the direction indicated by arrow 194.

In operation according to methods of the exemplary embodiment, gases of a first gas stream 106 flowing in the first portion 104A of conduit 102 are directed into inlet duct 114 of the stack gas decontamination system 100 as inlet gas stream 116. A typical first gas stream 106 (and, hence, inlet gas stream 116) resulting from a combustion process may include sulfur dioxide (SO₂) in a concentration of 300 to 800 parts per million (ppm), various nitrogen oxides (NOₓ) in a concentration of 120 to 225 ppm, and water vapor in a concentration of 5 to 10 percent. The inlet duct 114 directs the inlet gas stream 116 to the cooling tower 112. Contemporaneously, the cooling tower 112 receives cool water from water source 118 via pipeline 120. Using the received cool water, the cooling tower 112 reduces the temperature of the gases of the inlet gas stream 116 to approximately sixty-five degrees Celsius (65° C.). The cooled gases of the inlet gas stream 116 then exit the cooling tower 112 and flow through connecting duct 124 to reactor 122.

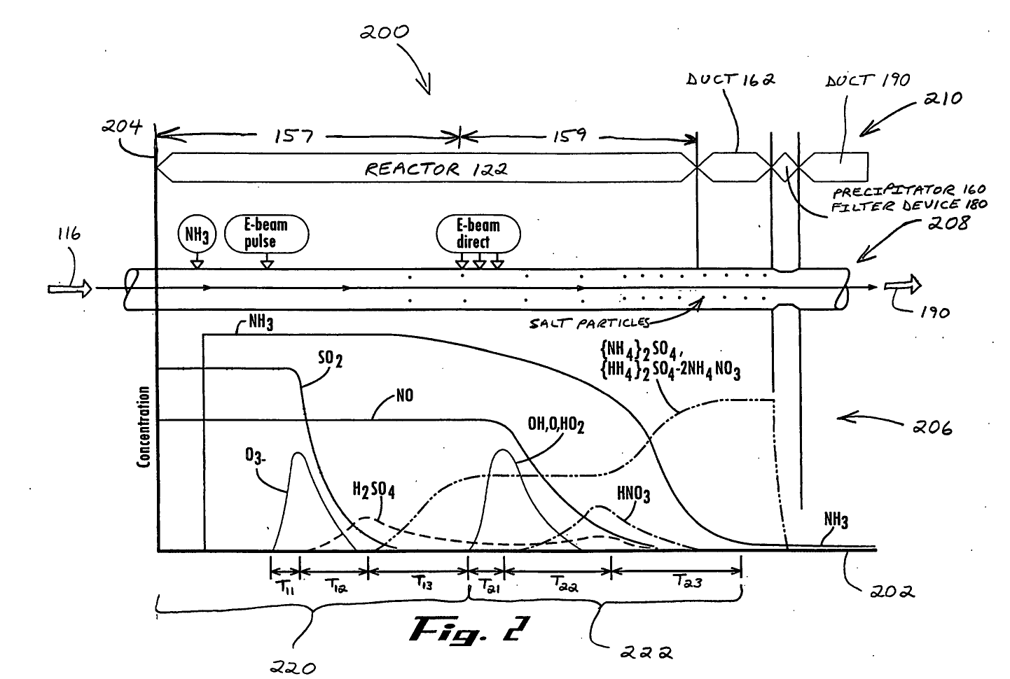

FIG. 2 displays a diagram 200 illustrating the treatment of the gases of the inlet gas stream 116 (and, the effects thereof by the remaining portion of the stack gas decontamination system 100 in accordance with methods, or processes, of the exemplary embodiment of the present invention. The diagram 200 has a horizontal axis 202 that indicates time, in seconds, and a vertical axis 204 that indicates the concentration of the various chemical compounds present in the gases of the inlet and treated gas streams 116, 164 during processing. The vertical axis 204 is positioned at the left side of the diagram 200 and its location corresponds to the time at which the cooled inlet gas stream 116 enters reactor 122 as described below.

The diagram 200 includes a lower portion 206, a middle portion 208, and an upper portion 210. The lower portion 206 comprises a plurality of curves illustrating, in graphical form, the concentration and the change in concentration of the various respective chemical compounds, radicals, and ions that are present in the inlet and treated gas streams 116, 164 relative to time during the processing thereof. The middle portion 208 illustrates, in block diagram form, the times during processing of the inlet and treated gas streams 116, 164 at which ammonia and electron beams are injected into reactor 122 and the increasing creation, over time, of sulfuric and nitric acid salts, in particulate or powder form, all relative to (i) the position of the inlet and treated gas streams 116, 164 in the reactor 122, connecting duct 162, precipitator 160, filter device 180, and outlet duct 190, and (ii) the concentration of the various respective chemical compounds therein. The upper portion 210 illustrates, in timing diagram form, the position of the gases of the inlet and treated gas streams 116, 164 within the reactor 122, connecting duct 162, precipitator 160, filter device 180, and outlet duct 190 relative to (i) the injection of ammonia and electron beams into reactor 122, and (ii) the concentration of the various respective chemical compounds.

Continuing now with the description of the methods, or processes, of the stack gas decontamination system 100 with reference to FIGS. 1 and 2, the gases of the inlet gas stream 116 enter reactor 122 near the first end 126 thereof and begin traveling toward the second end 128 thereof through the reactor's first portion 157 during a corresponding first stage 220 of processing. Ammonia, delivered from ammonia source 130 by pipeline 132, is injected into the reactor 122 and into the gases of the inlet gas stream 116 upon entering reactor 122. As the gases of the inlet gas stream 116 and ammonia flow toward the second end 128 of reactor 122 through the reactor's first portion 157 and past waveguide 144, the pulsed electron accelerator 140 (i.e., using high-voltage power produced by high-voltage power supply 142 and delivered by high-voltage power cable 146) emits an electron beam, including pulses of electrons, into the gases via waveguide 144.

The treatment of the gases by the emission of the electron beam into the gases initiates a series of ion-molecular reactions of nitrogen (N₂), oxygen (O₂), and water vapor (H₂O) that result in the generation of O₃⁻ ions and accompanying free electrons (e⁻) predominantly during a first time period, T₁₁ (where the first subscript denotes the stage of processing and the second subscript denotes the time period thereof, of the first stage 220 of processing (see FIG. 2). The ion-molecular reactions continue during a second time period, T₁₂, of the first stage 220 of processing in which sulfur dioxide (SO₂), water vapor (H₂O), and O₃⁻ ions substantially react to form sulfuric acid (H₂SO₄). During a third period, T₁₃, of the first stage 220 of processing, the ion-molecular reactions continue with sulfuric acid (H₂SO₄) created during the second time period, T₁₂, reacting substantially with ammonia (NH₃) and water vapor (H₂O) to produce ammonium sulfate ((NH₄)₂SO₄). Together, this series of ion-molecular reactions occurring predominantly during respective time periods, T₁₁, T₁₂, and T₁₃ in the ammonium environment produced by the injection of ammonia into the reactor 122, causes the conversion of the majority of sulfur dioxide (SO₂) into ammonium sulfite ((NH₄)₂SO₃), ammonium sulfate ((NH₄)₂SO₄), and complex salts ((NH₄)₂SO₄×2NH₄NO₃), hence removing the majority of sulfur dioxide (SO₂) from the gases of the inlet gas stream 116 during the first stage 220 of processing and while the gases are present in the first portion 157 of reactor 122. In accordance with the exemplary embodiment, the time periods T₁₁, T₁₂, and T₁₃ have respective durations of approximately 10⁻⁸ seconds, 10⁻⁵ seconds, and 10⁻¹ to 1 second.

The treatment of the gases of the inlet gas stream 116 (now partially treated and sometimes referred to herein as treated gas stream 164) continues, according to the methods of the exemplary embodiment and during a second stage 222 of processing, as the gases flow from the first portion 157 of reactor 122 into the second portion 159 thereof. Upon entering the second portion 159 of reactor 122, the gases of the treated gas stream 164 are irradiated by electron beams that are produced from the direct current electron accelerators 150 (using high-voltage electrical power received from high-voltage power supply 152 via respective high-voltage power cables 154) and emitted into reactor 122 via respective waveguides 156. The irradiation of the gases in the ammonium environment by the direct current electron accelerators 150 initiates a series of reactions with free radicals that, upon their completion, result in the majority of the nitrogen oxides (NOₓ) present in the inlet and treated gas streams 116, 164 being removed therefrom and converted into ammonium nitrite (NH₄NO₃) in powder or particulate form. The irradiation by the direct current electron accelerators 150 also causes further ion-molecular reactions, substantially similar to those described above with respect to the first stage 220 of processing, to occur with any remaining sulfur dioxide (SO₂) being similarly removed from the gases by conversion into sulfuric acid salt in powder or particulate form.

The series of reactions initiated by the direct current electron accelerators 150 begins with OH, O, and HO₂ radicals and free electrons (e⁻) being formed from nitrogen (N₂), oxygen (O₂), and water vapor (H₂O) predominantly during a first time period, T₂₁, of the second stage 222 of processing in the second portion 159 of reactor 122 (see FIG. 2). Next, during a second time period, T₂₂, of the second stage 222 of processing, the previously formed OH, O, and HO₂ radicals and free electrons (e⁻) combine with the nitrogen oxides (NOₓ) and any remaining sulfur dioxide (SO₂) present in the inlet and treated gas streams 116, 164 to, respectively, produce nitric acid (HNO₃) and sulfuric acid (H₂SO₄). Subsequently, during a third time period, T₂₃, of the second stage 222 of processing, the previously produced sulfuric acid (H₂SO₄) reacts with ammonia (NH₃) and water vapor (H₂O) present in the reactor 122 to create ammonium sulfate ((NH₄)₂SO₄), and any previously produced ammonium sulfite ((NH₄)₂SO₃) and ammonium sulfate ((NH₄)₂SO₄) reacts with nitric acid (HNO₃), ammonia (NH₃), and water vapor (H₂O) to form complex salts ((NH₄)₂SO₄×2NH₄NO₃) in particulate or powder form, thereby completing the removal of a majority of the sulfur dioxide (SO₂) and nitrogen oxides (NOₓ) present in the inlet and treated gas streams 116, 164 (see FIG. 2). In accordance with the exemplary embodiment, the time periods T₂₁, T₂₂, and T₂₃ have respective durations of approximately 10⁻⁸ seconds, 10⁻⁵ seconds, and 10⁻¹ to 1 second.

With the majority of the sulfur dioxide (SO₂) and nitrogen oxides (NOₓ) present in the inlet and treated gas streams 116, 164 now removed, the gases of the treated gas stream 164 (and the sulfuric and nitric acid salts entrained therein) exit the second portion 159 of reactor 122 through connecting duct 162 near the second end 128 thereof. The connecting duct 162 directs the treated gas stream 164 (and the sulfuric and nitric acid salts entrained therein) to the precipitator 160 where a portion of the sulfuric and nitric acid salts, in powder form, are removed and delivered, via conveyor 168, to the solids disposal system 166 for subsequent appropriate disposal. The treated gas steam 164, including any remaining entrained sulfuric and/or nitric acid salts in powder, or particulate, form, exits the precipitator 160 and is directed into filter device 180 by connecting duct 184. The filter device 180 receives the treated gas stream 164 and removes a portion of any additional sulfuric and/or nitric acid salts in powder form that were not removed by the precipitator 160. The removed sulfuric and/or nitric acid salts are then delivered from the filter device 180 to the solids disposal system 166 by conveyor 186 for subsequent appropriate disposal.

Proceeding, the treated gas stream 164, including any remaining entrained sulfuric and/or nitric acid salts in particulate form, are induced to flow into the intake of fan 182 through connecting duct 188. The treated gas stream 164, including any entrained remaining sulfuric and/or nitric acid salts, exits the outlet of the fan 182 into outlet duct 190 as outlet gas stream 192. After traveling through outlet duct 190, the outlet gas stream 192 enters the second portion 104B of conduit 102 for direction toward the atmosphere or toward a device that is not part of the stack gas decontamination system 100.

Importantly, the stack gas decontamination system 100 requires less energy to remove nitrogen oxides (NOₓ) from the gases of the inlet gas stream 116 than would otherwise be required because the majority of the sulfur dioxide (SO₂) has already been removed therefrom during the first stage 220 of processing and, hence, the concentration of sulfur dioxide (SO₂) is already low when the second stage 222 of processing begins. Such reduction in the required energy has been proven, based on test results, by comparing the energy consumption of a similar stack gas decontamination system in which no pulsed electron accelerator 140 is used during processing to remove sulfur dioxide (SO₂) (i.e., such system uses only a single stage for processing the gases of the inlet gas stream 116) and the energy consumption of the stack gas decontamination system 100 of the present invention. When no pulsed electron accelerator 140 is used to remove sulfur dioxide (SO₂), the energy consumption to do so is approximately ten electron volts (10 eV) to twenty electron volts (20 eV) per molecule of decontaminated gas. When a pulsed electron accelerator 140 is used to remove sulfur dioxide (SO₂) as in the stack gas decontamination system 100 of the present invention, the energy consumption to do so is approximately one electron volt (1 eV) to five electron volts (5 eV) per molecule of decontaminated gas.

Further, when dual-stage irradiation of the gases of inlet gas stream 116 is performed using the stack gas decontamination system 100 of the present invention, the efficiency of the removal of nitrogen oxides (NOₓ) depends on the concentration of sulfur dioxide (SO₂) present prior to the start of the second stage 222 of processing (i.e., prior to starting the removal of nitrogen oxides (NOₓ) removal). Based on test results with all other conditions being equal, for an initial nitrogen oxide (NOₓ) concentration of 170 ppm and an initial sulfur dioxide (SO₂) concentration of 360 ppm, the removal efficiency of the nitrogen oxides (NOₓ) is seventy-three percent (73%). For an initial nitrogen oxide (NOₓ) concentration of 170 ppm and an initial sulfur dioxide (SO₂) concentration of 310 ppm, the removal efficiency of the nitrogen oxides (NOₓ) is eighty-one percent (81%). As a consequence, the cumulative amount of energy required to remove sulfur dioxide (SO₂) and nitrogen oxides (NOₓ) from the gases of an inlet gas stream using the present invention's two stages of irradiation with the majority of sulfur dioxide (SO2) being removed through use of a pulsed electron accelerator is reduced by twenty-five percent (25%) to thirty percent (30%) when compared to single stage systems using only direct current electron accelerators.

Whereas this invention has been described in detail with particular reference to an exemplary embodiment and variations thereof, it is understood that other variations and modifications can be effected within the scope and spirit of the invention, as described herein before and as defined in the appended claims.

What is claimed is:

1. A system for removing sulfur dioxide and a nitrogen oxide from a gas stream including sulfur dioxide and a nitrogen oxide, said system comprising:
a reactor for receiving a gas stream including sulfur dioxide and a nitrogen oxide and for allowing said gas stream to flow therein;
a first electron accelerator configured to irradiate said gas stream as said gas flows within said reactor during a first stage of processing; and,
a second electron accelerator configured to irradiate said gas stream as said gas flows within said reactor during a second stage of processing.

2. The system of claim 1, wherein said reactor has a first end and a second end distal from said first end, and wherein said first electron accelerator is positioned nearer said first end of said reactor than said second electron accelerator.

3. The system of claim 2, wherein said first electron accelerator comprises a pulsed electron accelerator and said second electron accelerator comprises a direct current electron accelerator.

4. The system of claim 2, wherein said reactor has a longitudinal axis extending between said first end and said second end, wherein said first electron accelerator and said second electron accelerator are separated by a distance measured along said longitudinal axis and having a value of approximately five meters.

5. The system of claim 1, wherein said reactor has a first end and a second end distal from said first end, and wherein said second electron accelerator is positioned nearer said first end of said reactor than said first electron accelerator.

6. The system of claim 5, wherein said first electron accelerator comprises a pulsed electron accelerator and said second electron accelerator comprises a direct current electron accelerator.
